(19) United States
(12) Patent Application Publication
(10) Pub. No.: US 2013/0064676 A1
(43) Pub. Date: Mar. 14, 2013

(54) COMPOSITE FILLED METAL AIRFOIL

(71) Applicants: George Alan Salisbury, East Hampton, CT (US); Phillip Alexander, Colchester, CT (US); Carl Brian Klinetob, East Haddam, CT (US)

(72) Inventors: George Alan Salisbury, East Hampton, CT (US); Phillip Alexander, Colchester, CT (US); Carl Brian Klinetob, East Haddam, CT (US)

(73) Assignee: UNITED TECHNOLOGIES CORPORATION, Hartford, CT (US)

(21) Appl. No.: 13/231,215

(22) Filed: Sep. 13, 2011

(51) Int. Cl. F01D 5/14; B23P 15/02

(52) U.S. Cl. 416/229 R; 29/889.71

(57) ABSTRACT

A method of forming an airfoil includes forming a metal portion of the airfoil including a tip, a leading edge, a trailing edge, a pressure side and a suction side; forming a plurality of grooves into one side of the airfoil; and filling the plurality of grooves with composite material.

### BACKGROUND

Titanium alloys and organic matrix composite are the benchmark classes of materials for fan and compressor blades in commercial airline engines. One reason for the materials being so broadly adopted is that regulations require an engine in commercial service to be capable of ingesting various sizes and quantities of birds while allowing for continued operation or safe and orderly shutdown of that engine. Another reason is that the blades must resist cracking from nicks and dents caused by small debris such as sand, hail and rain. Engines with titanium fan blades as well as certain reinforced fiber composite fan blades are the predominant configurations that currently meet these criteria.

While titanium blades are relatively strong and light in weight, composite blades may offer sufficient strength and a significant weight savings over titanium. However, composite blades do not scale well to smaller engine applications and currently, the costs are several times those of comparably sized titanium blades. Both titanium and fiber composite raw materials are also expensive to process. These blades often require expensive specialized equipment to process the material into an aerodynamic shape that maintains strength while keeping weight to a minimum. Further, due to their relatively low strain tolerance, portions of composite blades require a greater thickness than otherwise equivalent metal blades to meet certain requirements, for example, bird strike requirements. Greater blade thickness reduces fan efficiency and offsets a significant portion of weight savings from using composite materials.

### SUMMARY

A method of forming an airfoil includes forming a metal portion of the airfoil including a tip, a leading edge, a trailing edge, a pressure side and a suction side; forming a plurality of grooves into one side of the airfoil; and filling the plurality of grooves with composite material.

A fan blade includes a metallic airfoil with a leading edge and a trailing edge separated in a chordwise direction, a root and a tip separated in a spanwise direction, and a suction face and a pressure face separated in a thickness direction; and one or more grooves in one of the faces of the airfoil, wherein at least a portion of the one or more grooves filled with composite materials.

### BRIEF DESCRIPTION OF THE DRAWINGS

FIG. 1 schematically depicts a cross-section of a typical turbine engine.

FIG. 2 is a side view of a composite filled metal blade.

FIG. 3A shows a cross-section for grooves containing composite in the metal blade of the current invention.

FIG. 3B is a second embodiment showing cross-sections for grooves containing composite in the composite filled metal blade of the current invention.

FIG. 3C is a third embodiment showing cross-sections for grooves containing composite in the composite filled metal blade of the current invention.

FIG. 3D is a fourth embodiment showing cross-sections for grooves containing composite in the composite filled metal blade of the current invention.

FIG. 4 is a block diagram of a method of forming a composite filled metal blade.

### DETAILED DESCRIPTION

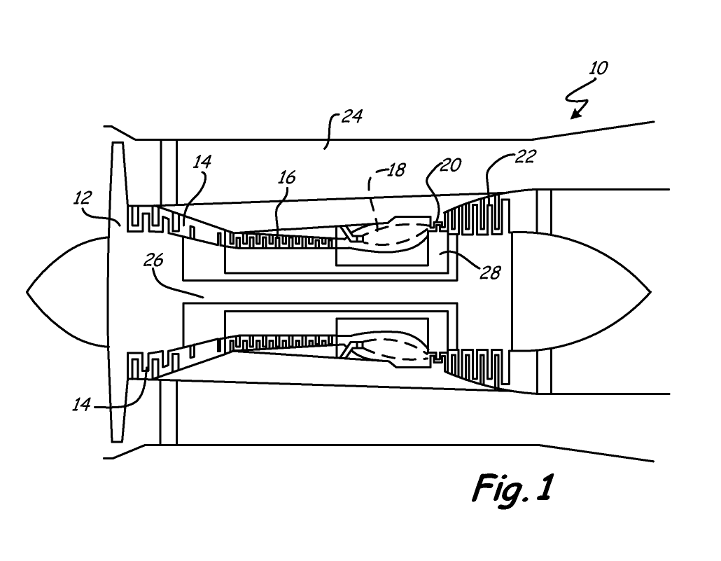

An example dual-spool turbofan engine is depicted in FIG. 1. Turbofan engine 10 comprises several sections: fan section 12, low-pressure compressor section 14, high-pressure compressor section 16, combustor section 18, high-pressure turbine section 20, low-pressure turbine section 22, bypass section 24, low-pressure shaft 26, and high-pressure shaft 28. A portion of the atmospheric air pulled in by rotation of fan section 12 is directed toward first compressor section 14, while the remainder is directed through bypass section 24. Air directed through first compressor section 14 is further compressed by second compressor section 16. Fuel is added and ignited in combustor section 18. Blades in turbine sections 20 and 22 capture a portion of the energy from passing combustion products by turning turbine rotors. Both fan section 12 and compressor section 14 are rotatably linked via low-pressure shaft 26 or geared-coupling to low-pressure power turbine section 22. High-pressure compressor section 16 is rotatably connected to high-pressure turbine section 22 via high-pressure shaft 28. Thrust is generated in engine 10 by the remaining atmospheric air drawn in by fan section 12 and forced through bypass section 24, as well as by the force of exhaust gases exiting from second low-pressure turbine 22. Those skilled in the art recognize that other architectures exist, for example, those with architectures with centrifugal compressors and with added intermediate compressor and turbine sections.

In a turbofan engine, lighter components generally lead to more efficient performance. The components must also be strong enough to withstand forces typical for the operating environment and performance envelope. Safety considerations based on the frequency and/or severity of possible failure will often dictate that the engine components also be able to withstand certain atypical, yet foreseeable events as well. Because stronger components are often heavier and/or more expensive, a balance must be struck between efficiency, safety, and cost. The current invention uses a mix of high strength metallic components as well as light-weight composite materials to achieve this balance of efficiency, safety and cost and improve blade performance in relation to other characteristics, such as tuning, damping, and dimensional stability and repeatability.

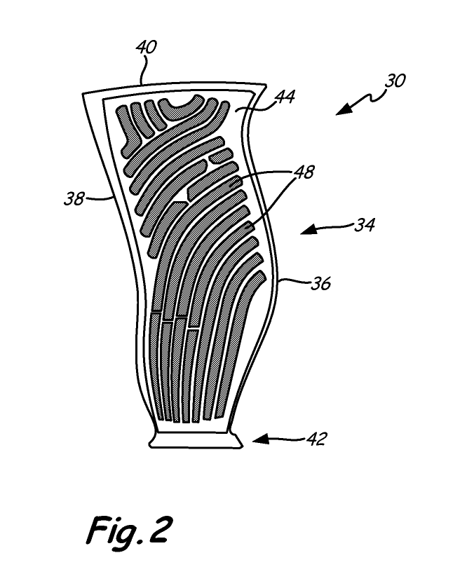

FIG. 2 is a side view of a composite filled metal airfoil, illustrated as a fan blade although other airfoils may also be used. Blade 30 includes airfoil 34 with leading edge 36, trailing edge 38, tip 40, root 42, suction side 44, pressure side 46 (not shown) and composite filled grooves 48.

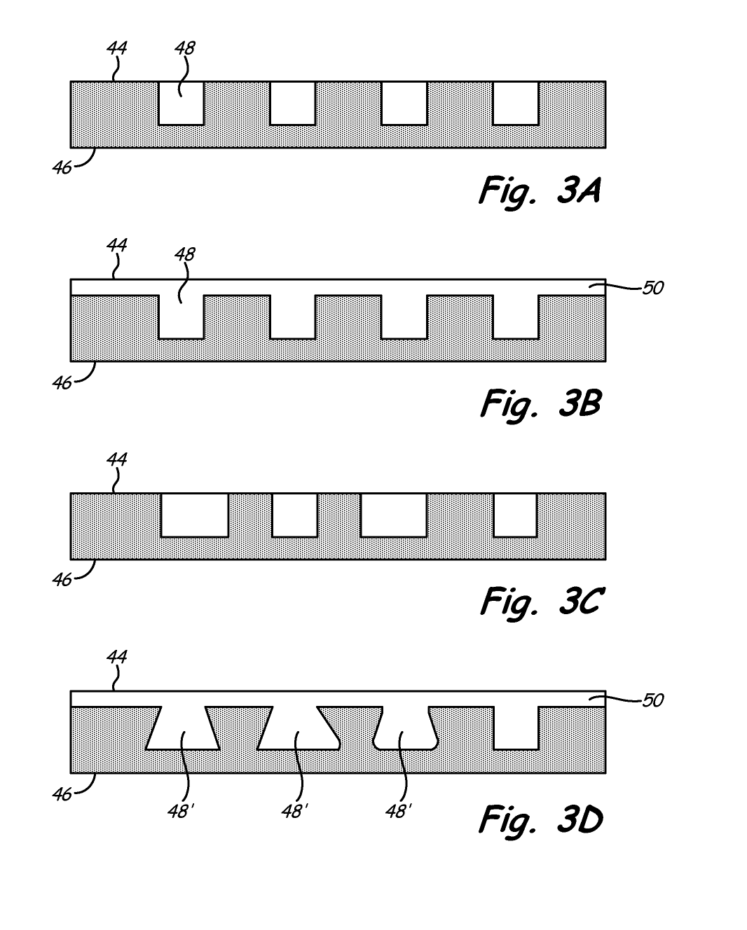

One or more composite filled grooves 48 are located on suction side 44 of airfoil 34 in this embodiment. Metallic parts of blade 30 can be titanium (including titanium alloys), aluminum (including aluminum alloys) and/or any other suitable metal. Grooves 48 can be machined into airfoil 34 suction side 44 towards pressure side 46. Composite material can consist of filler materials, such as chopped fibers, a braided rope, tape, other materials or a combination of materials cured with resin. Filler materials can be dry and have resin added or can be pre-impregnated with resin. Additionally, composite materials can be mechanically locked into grooves 48 (see FIG. 3D) by the cross-sectional shape of grooves 48. While grooves 48 are located on suction side 44 of airfoil 34 in FIG. 1, alternative embodiments could locate grooves on pressure side 46 of airfoil 34.

Composite filled grooves 48 act with metal portions of blade 30 to define airfoil 34. Replacing parts of metallic blade 30 with composite filled grooves 48, decreases weight of blade 30 while still maintaining sufficient strength to resist impacts. Additionally, the placement and design of grooves can improve blade resistance to aero-mechanical vibrations known as flutter, affect tuning of the blade, change structural properties such as strength and stiffness, and improve dimensional stability and repeatability.

Blade 30 has a natural frequency. If that frequency corresponds to certain engine operating conditions, blade 30 can be subject to aero-mechanical vibrations called flutter. Flutter can lead to large amounts of strain on blade 30, which can eventually result in blade 30 cracking and possible total blade 30 failure. To minimize flutter, composite filled grooves 48 can be added in selected areas of blade 30, affecting the tuning of the natural frequency to avoid frequencies corresponding to engine states used most often, such as idle or cruise. Composite filled grooves 48 can also affect blade 30 stiffness to further resist vibrations and flutter.

Dimensional stability and repeatability can be improved through blade 30 with composite filled grooves 48 due to use of mostly metal in blade 30. The surface profile of fully composite blades can be difficult to control and repeat in manufacture due to the process of forming and curing the composite. Forming root 42, tip 44, leading edge 36, trailing edge 38 and pressure side of blade 30 of metal limits the more difficult composite to a much smaller area (only composite in grooves 48). This results in a more stable and repeatable blade 30.

FIG. 3A shows a cross-section for grooves containing composite in the metal blade of the current invention. FIG. 3B is a second embodiment showing cross-sections for grooves containing composite in the composite filled metal blade of the current invention. FIG. 3C is a third embodiment showing cross-sections for grooves containing composite in the composite filled metal blade of the current invention. FIG. 3D is a fourth embodiment showing cross-sections for grooves containing composite in the composite filled metal blade of the current invention. FIGS. 3A-3D include portion of blade 30 with suction side 44, pressure side 46, composite filled grooves 48. FIGS. 3B and 3D additionally include cover ply 50, and FIG. 3D includes mechanical locking grooves 48′.

Composite materials can consist of resin cured with filler materials such as chopped fiber, tows, ropes, tapes, other materials or a combination of materials depending on blade requirements. The filler material can be dry and then be injected with resin or can be pre-impregnated with resin. Composite material can be formed in grooves 48 by placing the filler materials in grooves, adding resin (if filler material is not pre-impregnated) and curing.

FIG. 3A shows grooves 48 uniformly spaced and filled with composite materials.

FIG. 3B shows grooves 48 uniformly spaced, filled with composite materials and with additional cover ply 50. Cover ply 50 can be formed from similar materials to the composite material in grooves 48. Cover ply 50 can be connected to composite material in grooves 48 by interlocking strands between the composites in grooves 48 and cover ply 50. Cover ply 50 can provide continuity between grooves 48 and can also provide additional structure, stiffness and damping properties to blade 30.

FIG. 3C shows tailored spacing of composite filled grooves 48. Grooves 48 are varied in size and spacing to affect blade properties, such as tuning, strength and stiffness.

FIG. 3D shows tailored spacing of mechanically locking composite filled grooves 48′. Grooves 48′ mechanically lock composite materials in by having a wider cross-section within airfoil 34 than at pressure face 44. Additionally, FIG. 3D includes cover ply 50 that can be connected to composite materials in grooves 48′ by interlocking strands or another method known in the art. The mechanical locking of composite materials by grooves 48′ helps to retain composite materials in grooves 48′ even under extreme situations, such as during an impact strike.

The addition of composite filled grooves 48 to airfoils and tailoring the spacing, size, and shape of those grooves 48 allows for a lighter-weight blade with improvements in resistance to flutter, strength and stiffness. The varying of groove 48 characteristics and size allows for metal blade with composite filled grooves to be useful in many different situations. The size and spacing of composite filled grooves 48 can be varied according to blade size and type, engine size and type, desired blade characteristics and many other factors. Additionally, by shaping grooves 48′ to mechanically lock in composite materials, blade 30 retains much of the durability of blades made of a single material. The use of composite materials in grooves 48 and/or in cover ply 50 can also eliminate the need for erosion coatings needed to protect metal blades from erosion.

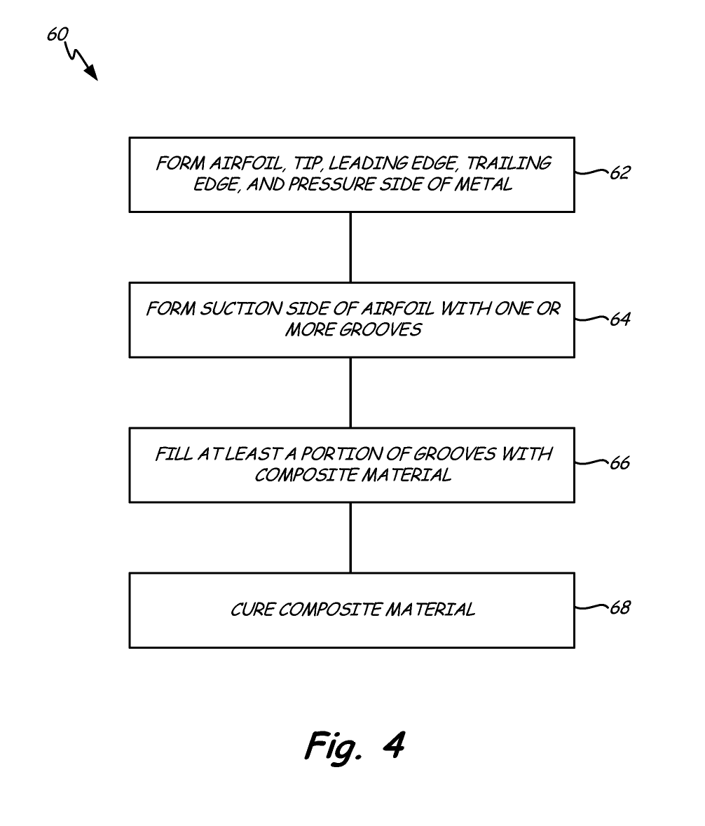

FIG. 4 is a block diagram of a method of forming a composite filled metal airfoil. Method 60 includes forming airfoil tip, leading edge, trailing edge and pressure side of metal (step 62), forming airfoil suction side of metal with one or more grooves (step 64), filling at least a portion of the grooves with composite materials (step 66) and curing the composite material (step 68).

Forming airfoil tip, leading edge, trailing edge and pressure side of metal (step 62) can be done by machining titanium or another metal to form airfoil dimensions desired.

Forming airfoil suction side of metal with a plurality of grooves (step 62) can be done by machining grooves into suction side of airfoil. In alternative embodiments, grooves could be machined into pressure side of airfoil. Number of grooves and groove spacing, size and shape can be determined based on airfoil, blade and engine requirements and desired blade characteristics. Grooves can be shaped to have a negative draft at the opening on suction side for mechanical locking of composite material in grooves (see FIG. 3D). Forming of airfoil suction side can also include machining suction side of airfoil to remove a portion of metal adjacent to the grooves to allow for a cover ply over the grooves and a part of the suction side of the airfoil (see FIGS. 3B, 3D).

Filling at least a portion of grooves with composite materials (step 66) can be done using filler material such as chopped fiber, tows, ropes, tapes, other materials or a combination of materials depending on blade requirements. The filler material is then cured with resin to form the composite material. The filler material can be dry and then be injected with resin or can be pre-impregnated with resin. If a cover ply is used, the cover play can be attached to composite material in grooves by interlocking fibers.

Curing the composite material (step 68) can be done in a variety of different ways and at different temperatures, depending on the composite filler materials and resin used to fill grooves. Curing ensures that the composite material sets properly with the airfoil to result in a high-strength, light-weight airfoil.

The filling and curing of composite materials in grooves (steps 66 and 68) allows for the use of composite materials without the challenges of forming entire airfoil surfaces of composite materials. Grooves 48 act as a type of mold, resulting in the need to only control the forming of one surface of the composite material.

In summary, forming composite filled grooves into a metal airfoil results in a high-strength, light weight blade that is adaptable to a variety of different requirements and desires. The use of metal through much of the airfoil ensures that airfoil 34 retains much of the strength of fully metal airfoils, and the addition of composite filled grooves 48 reduces the overall weight of blade 30. The ability to tailor the size, shape, location and spacing of grooves allows for the use of blade 30 in a variety of different engines and situations. Grooves can be tailored to increase or decrease strength or stiffness in particular areas and adjust tuning of the blade to resist flutter or vary other blade properties as desired. Additionally, the use of composite materials can eliminate the need for erosion coatings on the side of blade where composite filled grooves 48 are located.

As noted above, while composite filled grooves are shown to be located on suction side of airfoil, in alternative embodiments grooves could be located on pressure side of airfoil. Grooves shown in FIG. 2 are for example purposes only, and in other embodiments, grooves could be varied in shape, size and location. While a plurality of grooves are shown in example embodiments, alternative embodiments can include only one groove. Additionally, while forming of blade metal sections has been discussed in relation to machining, they could also be formed by casting or other methods depending on requirements.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

What is claimed is:

1. A method of forming an airfoil, the method comprising:
forming a metal portion of the airfoil including a tip, a leading edge, a trailing edge, a pressure side and a suction side;
forming a plurality of grooves into one side of the airfoil; and
filling the plurality of grooves with composite material.

2. The method of claim 1, wherein the step of forming a plurality of grooves into one side of the airfoil comprises:
forming one side of the airfoil with a plurality of grooves to mechanically lock the composite material into the groove.

3. The method of claim 1, and further comprising:
curing the composite material.

4. The method of claim 1, and further comprising:
injecting the composite material with resin; and
curing the composite material.

5. The method of claim 1, wherein the step of forming a metal portion of the airfoil comprises machining a metal portion of the airfoil.

6. The method of claim 1, wherein the step of forming a plurality of grooves into one side of the airfoil further comprises
machining the side of the airfoil to remove a portion of metal adjacent to the grooves.

7. The method of claim 6, and further comprising:
attaching a cover ply over a portion of the side of the airfoil where metal adjacent to the grooves has been removed.

8. The method of claim 1, wherein the grooves are formed in the pressure side of the airfoil.

9. The method of claim 1, wherein the grooves are formed in the suction side of the airfoil.

10. The method of claim 1, wherein the airfoil comprises a fan blade.

11. A fan blade comprising:
a metallic airfoil with a leading edge and a trailing edge separated in a chordwise direction, a root and a tip separated in a spanwise direction, and a suction face and a pressure face separated in a thickness direction; and
one or more grooves in one of the faces of the airfoil, wherein at least a portion of the one or more grooves filled with composite materials.

12. The blade of claim 11, wherein the one or more grooves have a shape that mechanically locks the filler material into the groove.

13. The blade of claim 12, wherein the shape of the one or more grooves includes a cross section that is wider within the airfoil than at the face surface.

14. The blade of claim 11, wherein the location of the one or more grooves is in the suction face of the airfoil.

15. The blade of claim 11, wherein the location of the one or more grooves is in the pressure face of the airfoil.

16. The blade of claim 11, wherein at least a portion of the face of the blade with the one or more grooves is covered by a cover ply of composite material woven into the composite material in the one or more grooves.

17. A method of forming a lightweight metallic blade with composite components, the method comprising:
forming a metallic blade with a root, a tip, a leading edge, a trailing edge, a pressure side and a suction side, wherein one of the pressure side and the suction side has grooves formed from the side surface extending into the blade towards the other side; and
filling the grooves with a composite material.

18. The method of claim 17, wherein the grooves are formed to mechanically lock in the composite material.

19. The method of claim 17, wherein the step of forming the blade comprises:
forming a root, tip, leading edge, trailing edge, pressure side and suction side; and
creating a plurality of grooves on one of the pressure side or the suction side.

20. The method of claim 19, wherein grooves are created by machining.
